(19) United States
(12) Patent Application Publication
(10) Pub. No.: US 2010/0263106 A1
(43) Pub. Date: Oct. 21, 2010

(54) FOAMED POLYMER

(75) Inventors: Mikhail Kassam, Toronto (CA); Aziz Navrozally, Markham (CA); Akil Jaffer, Markham (CA)

Correspondence Address: MARSHALL & MELHORN, LLC, FOUR SEAGATE - EIGHTH FLOOR, TOLEDO, OH, 43604, US

(73) Assignee: MIDAS SAFETY, INC., North York (CA)

(21) Appl. No.: 12/763,239

(22) Filed: Apr. 20, 2010

(30) Foreign Application Priority Data
Apr. 20, 2009 (GB) 0906727.3

(51) Int. Cl. A41D 19/00; C08J 9/16; B05D 3/10

(52) U.S. Cl. 2/164; 521/56; 427/336

(57) ABSTRACT

A method for manufacturing a foamed polymer is disclosed, the method comprising, providing a precursor dispersion comprising a precursor of a gellable polymer, particles of a water-swellable polymer and water, and gelling the gellable polymer to form a solid polymer. The method may be used to manufacture a garment, especially a glove. Also disclosed are gloves comprising a liner and at least one foamed polymer layer coated on the liner the foamed polymer layer comprising micropores formed by water swelling and contraction of particles of a water swellable polymer and mesopores formed by gas incorporated in the foamed polymer.

### FIELD OF THE INVENTION

The present invention relates to methods for manufacturing foamed polymers, to methods for manufacturing garments comprising the foamed polymers and to gloves having foamed polymer layers.

### BACKGROUND TO THE INVENTION

It is known to produce foamed polymers using blowing agents or by introducing gas bubbles into polymers.

However, the use of blowing agents can lead to environmental problems because many blowing agents are pollutants.

The use of conventional incorporated gas polymer foams also has disadvantages, especially in foam coating because foams with a large amount of incorporated gas have too low a density to flow or drain efficiently. There have been attempts to overcome this problem.

For example, EP-A-1608808 describes a process for making gloves involving foam dip coating a textile liner and including a step of actively removing excess foam by directing a liquid at the excess foam. Unfortunately, this process has disadvantages because the extra step slows production, and causes additional effluent (with consequent environmental problems).

Other attempts to obviate the disadvantages of foams in gloves manufacturing include restricting the amount of air incorporated into the dipping dispersion as in WO-A-2004/093580 or by avoiding the use of foams but adding a soluble salt to the dipped compound, to form a textured surface after washing as in US-A-2005/0035493. Unfortunately these approaches also lead to unnecessary effluent.

A further problem of conventional foam coating, especially in garments such as gloves, is that the nature of the foamed polymer may allow too rapid ingress of water, oil or other chemicals (e.g. glues).

### SUMMARY OF THE INVENTION

It is an aim of the present invention to overcome the disadvantages of the prior art.

The present invention accordingly provides a method for manufacturing a foamed polymer, the method comprising,
providing a precursor dispersion comprising a precursor of a gellable polymer, particles of a water-swellable polymer and water, and gelling the gellable polymer to form a gelled polymer.

Preferably the precursor of a gellable polymer is a plastisol or a latex. The more preferred latex is a latex of natural rubber, homopolymers or copolymers, for example, isoprene, chloroprene, acrylic ester acrylonitrile-butadiene copolymers, nitrile rubber, polychloroprene, styrene butadiene copolymers, butyl rubber, polybutadiene rubber, polyurethane or silicone.

Preferably the water swellable polymer is a natural polymer, a modified natural polymer, a polyacrylate or a polyamide. In particular, the water swellable polymer is preferably selected from gelatine, modified starch, modified cellulose, sodium polyacrylate, polyacrylamide copolymer, ethylene maleic anhydride copolymer, cross-linked carboxy methyl cellulose, polyvinyl alcohol copolymer, cross-linked polyethylene oxide, or a starch grafted copolymer of polyacrylonitrile.

Of these, the most preferred water swellable polymer is cross-linked carboxy methyl cellulose.

The great advantage of the method of the present invention is that a precursor dispersion can be prepared which enables a foamed polymer to be produced, but without the disadvantages of the prior art in that the use of the foamed polymer obviates the need for blowing agents and their possible environmental disadvantages. Furthermore, because the water swellable polymer swells in water and will, as a matter of course, contract after the gellable polymer has gelled and dried to form a solid polymer, the method of the present invention does not lead to unnecessary additional effluent being created.

Preferably, the pH of the precursor dispersion is in the range 8.5 to 11. This is advantageous because, surprisingly, water swellable polymers (especially crosslinked carboxy methyl cellulose) swell more rapidly in alkaline pH. pH higher than about 11 is not preferred because it may lead to destabilisation of some components of the precursor dispersion.

Generally, the water swellable polymer will expand very significantly in the presence of water. In the case of cross-linked carboxy methyl cellulose, this expansion might be 10, 20 or more times its original size. This swelling, in the precursor of the gellable polymer, means that when the gellable polymer has been gelled, drying of the gelled polymer, including the water swellable polymer, will result in contraction of the particles and in voids being formed in the solid polymer. Very surprisingly, subsequent immersion of the foamed polymer in water does not result in the particles swelling to the same extent nor as rapidly as in the manufacturing process. Thus, a foam polymer can be produced without the need to use blowing agents, or introduction of air by mechanical means.

Drying of the polymer may involve merely allowing the gelled polymer to dry at around room temperature. Alternatively, the gelled polymer may be heated at a temperature of, preferably, less than 120° C., more preferably less than 110° C., most preferably less than 100° C. in order to speed up drying of the water swollen polymer particles and foamed polymer.

It is preferred that the water swellable polymer comprises less than 30%, more preferably less than 20% and most preferably less than 15% by weight of water soluble material. This is because a significant amount of water soluble material may increase the viscosity of the precursor dispersion affecting the ease of use of the precursor dispersion.

Generally, the amount of water swollen particles of the water swellable polymer in the precursor dispersion will depend on the intended use. In one, preferred, embodiment, the water swollen particles of the water swellable polymer (i.e. after the particles have swollen in the presence of water) will form less than 50% by volume of the precursor dispersion. More preferably, the water swollen particles will form less than 30%, less than 25%, less than 20%, less than 15% by volume of the precursor dispersion.

The method of the present invention may further comprise introducing gas into the precursor dispersion to form a foam. The gas is preferably air. Introducing air into the precursor dispersion is preferably by (vigorously) agitating the precursor dispersion.

The advantages of having both air and water swellable particles in the precursor dispersion is that the voids in the solid polymer, once formed, can be modified by adjusting the relative content of gas and/or water swellable particles in the precursor dispersion. This can enable the solid polymer, once formed, to have voids of different sizes or different distribution of sizes which has significant advantages in a number of applications. Voids of differing sizes can be particularly important when the foamed polymer is used to coat garments because the different sizes of voids can improve the surface properties of the foamed polymer, in particular, (e.g. in the case of gloves) gripping properties.

It is preferred if less than 30% more preferably less than 25%, most preferably less than 20% by volume gas is introduced into the precursor dispersion.

In the most preferred embodiment approximately 15% by volume gas is introduced in the precursor dispersion (preferably as air) and about 15% by volume of the precursor dispersion is formed by water swollen particles.

Thus, in a second aspect of the present invention there is provided a method for manufacturing an foamed polymer, the method comprising,
providing a precursor dispersion comprising a precursor of a gellable polymer, particles of a water swellable polymer and water, adding gas to the precursor dispersion to form a foam, and gelling the gellable polymer to form a gelled polymer.

In all the aspects of the present invention, it is preferred if the gellable polymer is gellable by means of a coagulating agent. This would apply, for example, if the precursor was a latex of natural rubber, homopolymers or copolymers, for example, isoprene, chloroprene, acrylic ester acrylanitrile-butadiene copolymers, nitrile rubber, polychloroprene, styrene butadiene copolymers, butyl rubber, polybutadiene rubber, polyurethane or silicone.

Thus, preferably the method further comprises contacting the precursor dispersion with a coagulating agent to gel the gellable polymer.

Preferably, the coagulating agent comprises a water soluble nitrate or chloride, an alcohol (especially methanol), acetic acid, ascorbic acid or citric acid. In the most preferred embodiment, the coagulating agent comprises a calcium salt, most preferably calcium nitrate.

One use of the present invention is in dip coating substrates in order to form layers of foamed polymer. Thus, in a preferred embodiment, the invention further comprises dipping of a former into the precursor dispersion and gelling the gellable polymer. The former may be at least partially covered by a liner, preferably a textile liner. This is of particular use if the method is to be used to form a garment.

It is preferred (if the gellable polymer can be gelled using a coagulating agent) if the former is at least partially coated with coagulating agent before dipping. This may be achieved by dipping the former into a dispersion or solution of the coagulating agent and optionally drying the coagulating agent after removal of the former from the coagulating agent dispersion.

Depending on the application to which the method is to be used, the former may be coated with one or more layers of polymer either before or after dipping the former in the precursor dispersion. In this way, multilayer product may be formed, one of the layers being the layer of foamed polymer.

The present invention provides in a third aspect, a method for manufacturing a garment, the method comprising,
a) providing a former,
b) optionally covering the former with a liner,
c) providing a precursor dispersion comprising a precursor of a gellable polymer, particles of a water swellable polymer and water,
d) dipping the former in the precursor dispersion to form a layer of the precursor of a gellable polymer on the former,
e) removing the former from the precursor dispersion, and
f) gelling the gellable polymer.

In a fourth aspect, the present invention provides a method for manufacturing a garment, the method comprising,
a) providing a former,
b) optionally covering the former with a liner,
c) providing a precursor dispersion comprising a precursor of a gellable polymer, particles of a water swellable polymer and water,
d) introducing gas into the precursor dispersion to form a foam,
e) dipping the former in the precursor dispersion to form a layer of the precursor of a gellable polymer on the former,
f) removing the former from the precursor dispersion, and
g) gelling the gellable polymer.

Garments of the third and fourth aspects of the present invention are preferably gloves but may, alternatively, be socks or some other garment. The liner is preferably a textile liner. The textile liner preferably comprises one or more or a blend of two or more of nylon, cotton, spandex, lycra, polyester, aramid, dyneema, acrylic, carbon conductive fibre, copper conductive fibre, thunderon conductive fibre, multifilament yarn spun from liquid crystal polymer (available under the brand name Vectran™), tacte1, CoolMax™, ThermaStat™, Thermax™ and Viafil®.

The liner may be a non-woven, a woven or a knitted textile liner and is preferably knitted, more preferably weft knitted.

In a fifth aspect, the present invention provides a glove comprising a liner and at least one foamed polymer layer coated on the liner the foamed polymer layer comprising micropores formed by water swelling and contraction of particles of a water swellable polymer, and mesopores formed by gas incorporated in the foamed polymer.

In the sixth aspect, the present invention provides an unsupported glove comprising at least one layer of an foamed polymer the foamed polymer layer comprising micropores formed by water swelling and contraction of particles of a water swellable polymer and mesopores formed by gas incorporated in the foamed polymer.

The method of production of a glove comprising a liner, involves typically the following stages:
a) providing a former in the shape and size required of the glove.
b) covering the former, at least partially, with a liner (preferably a textile liner) of a suitable material.
c) dipping the former and liner in a dispersion of a coagulating agent (most preferably calcium nitrate dispersion in alcohol/water preferably methanol/water),
d) withdrawing the former and liner from the coagulating agent dispersion and, optionally drying the former and liner.
e) dipping the liner and former in the precursor dispersion prepared as discussed above.
f) withdrawing the liner and former from the precursor dispersion.
g) allowing the liner and former to drain.
h) dipping the liner and former in a second coagulating dispersion which may be, for example, calcium nitrate in methanol/water, or acetic acid in methanol/water, optionally drying after coagulation.
i) preferably leaching the gloves in water dispersion to remove excess coagulating agent and/or surfactants etc. followed by oven dying at 80 to 105° C.

Generally as the glove is removed from the precursor dispersion, it is covered with the gellable polymer and the coagulating agent acts to coagulate the polymer in the precursor dispersion thereby forming a layer on the surface of the liner.

As the glove dries, the water swellable particles in the glove contract leaving voids in the coagulated polymer and therefore providing an foamed polymer coating on the liner. If air is present in the precursor dispersion, then the finished glove will tend to have voids of a distribution of sizes: relatively large pores (often known as mesopores) formed by the presence of gas in the precursor dispersion as a foam, and relatively small pores (micropores) formed by the voids of the water swollen particles after contraction.

The process for producing an unsupported glove typically has the following steps.
a) a former of appropriate shape is dipped in a coagulating dispersion.
b) after optional drying, the former is dipped in a precursor dispersion which is to provide a layer which is the outside (grip) surface of the glove.
c) the former is removed from the precursor dispersion and the polymer starts to coagulate.
d) after a post dipping coagulation dip, the glove is dipped in a further dispersion of, usually, latex to provide a second, inner layer, to the glove.
e) optionally, the glove is then coated with a liner which may be, for example, flock.

There may also be optional leaching steps and/or drying steps at various stages in the process.

After drying, the finished glove is reversed off the former so that the layer which was first deposited on the former becomes the outer surface of the glove.

In a supported glove, the dipping process may be controlled so that the precursor dispersion does not fully penetrate the liner. In this way, the glove would have an inner surface that does not have exposed polymeric material, which is advantageous because some people have an allergic reaction to components in natural rubber or other polymers next to the skin. The non-penetrated portion of the liner would form a barrier between the wearer of the gloves and the coating of the polymeric material. Penetration of the dispersion into the liner may be controlled by modifying the viscosity of the precursor dispersion, controlling the time of dip and controlling the amount and concentration of coagulating agent on the liner. In addition, penetration of the polymer material into the liner, may be controlled by having a first, polymer layer on the liner. A first, solid polymer layer reduces or stops chemical ingress if the garment is to be used in the presence of noxious chemicals, including oils and glues.

A solid (i.e. non-foamed) polymer layer is also advantageous on unsupported gloves essentially for similar reasons. However, in the case of unsupported gloves, because of the way in which an unsupported glove is manufactured, the solid polymer layer would be deposited on the former after the foamed polymer layer.

After the deposition of the foamed polymer layer, a pattern may be applied using a heated pattern mould. This would be advantageous, in particular for gloves, because it may improve the grip on the gripping surface of the gloves.

Gloves produced according to the process of the present invention advantageously have micropores on the surface of the foamed polymer layer. There are typically between five and 50 pores/mm², more preferably between 10 and 40 pores/mm² and most preferably between 15 and 25 pores/mm². The control of the pore size and frequency is due to the particle size of the water swellable particles and the content of the water swellable particles in the dispersion.

Typically, foamed polymers according to the methods of the present invention are open cell as opposed to closed cell. This is advantageous because the foamed polymer is breathable (which is particularly advantageous when, for example, the foamed polymer is used to manufacture gloves) but nevertheless because of the microporous nature of the voids, may inhibit oil and glue penetration of the foamed polymer layer. In combination, the microporous surface and the relative inhibition of oils and glue into the foamed polymer enhances oil and wet grip when used on a glove. Further improved oil and wet grip is provided where gas is introduced into the precursor dispersion thereby providing both a microporous and a mesoporous surface on the foamed polymer layer.

### DETAILED DESCRIPTION OF THE INVENTION

Embodiments of the invention will now be described with reference to the following Examples.

### Example 1

In this example, a glove was produced having a liner and an foamed polymer coating on the liner. The foamed polymer coating has a micropores formed using water swellable particles.

The glove was manufactured in the flowing way,
1. a hand shaped former of the appropriate size was maintained at room temperature.
2. a textile liner of 15 gauge knitted nylon was loaded on the former.
3. a coagulating agent dispersion of 2.5% calcium nitrate and methanol in water was prepared.
4. the former with the liner was dipped in the precoagulating agent dispersion and removed.
5. after air drying for 70 seconds with the former in the down position and then 70 seconds with the former in the up position, the former and liner were dipped in the precursor dispersion at a slow dipping speed with two to three seconds dwell time.
6. after removal of the former from the precursor dispersion at a slow rate, the former was allowed to drain at 10 seconds in the downward position and 10 seconds in the upwards position.
7. a second, post coagulant treatment was conducted by dipping the former in a 15% calcium nitrate dispersion rapidly.
8. the polymer layer was allowed to gel for 15 minutes in the downward position at room temperature.
9. following this, the glove was pre-leached in water for 15 minutes at 30° C.
10. Finally, the former and glove were oven dried for 60 minutes at 80 to 110° C.

The precursor dispersion used in this example consisted of the components as listed in Table 1.

The viscosity of the dispersion was 280 to 320 cP. There was no air foam introduced in the precursor dispersion. The totals solids content was between 23 and 25 wt %. The pH of the dispersion was 8.5 to 9.0. Before dipping, the precursor dispersion was allowed to mature for 12 hours.

The swellable particles used in this example were cross-linked carboxy methyl cellulose obtained from FMC Corporation having a content of water soluble material of 1.0 to 10.0% by weight. Significantly more water soluble material can adversely affect the viscosity of the precursor dispersion as shown by the use of non-crosslinked carboxyl methyl cellulose as a thickener. It is preferred if the content of water soluble material is less than 30%, preferably less than 20% and most preferably below 15%.

Gloves produced according to this example have properties of grip and oil and water permeability as indicated in Table 2.

### Example 2

In Example 2a mixed mesoporous, microporous foam glove with liner was produced by introducing air into the precursor dispersion. The dipping process was conducted according to the procedure in Table 3. Air was introduced by agitation of the precursor dispersion in air.

The formulation of the precursor dispersion was as indicted in Table 1.

The oil and water grip and permeability properties of glove produced by this process are as indicated in Table 2.

TABLE 1

| | | Dry weight/ |
|---|---|---|
| | Formulation | arbitrary units |
| 1. | 45% Nitrile latex (NVT supplied by Polymer | 100.00 |
| | Latex) | |
| 2. | 30% Anionic surfactant (CALSOFT Pilot | 0.2 |
| | Chemicals) | |
| 3. | 50% Pre-dispersed blue pigment (LIGHT | 2.0 |
| | BLUE 5338) | |
| 4. | 50% Ground sulphur, 50% zinc diethyl | 4.0 |
| | dithio carbamate, 50% ZnO at 1:1:2 ratio | |
| 5. | 50% Wax emulsion (HYDROWAX 315) | 3.0 |
| 6. | 5% Cross-linked carboxy methyl cellulose, | 0.8 |
| | (1% to 10% water soluble material) | |
| 7. | 45% Antimicrobial sanitizing dispersion | 0.25 |
| | (antifungal etc.) | |
| 8. | 5% non-cross-linked carboxy methyl | Various, depending on |
| | cellulose (Methocel HPM 450 DS) as | desired viscosity |
| | thickener - fully soluble in water | |

TABLE 2

| | Dry Grip | | Wet Grip | | Oil Grip | | | | | Abrasion | | |
|---|---|---|---|---|---|---|---|---|---|---|---|---|
| | Metal | Glass | Metal | Glass | Metal | Glass | Water | Oil | Wearer | | No. | Weight |
| Example | Rod | Rod | Rod | Rod | Rod | Rod | Permeability | Permeability | Trials | Level | Cycles | Loss |
| 1 | 10 | 10 | 2 | 1 | NIL | NIL | 240 s slightly | Did not pass | 17 | 4 | 8000 | 146 mg |
| | | | | | | | pass through | through | | | | |
| 2 | 10 | 10 | 8 | 5 | 6 | 2 | 24 s | 150 s | 11 | 1 | 236 | 18 mg |
| Comp A | 10 | 10 | 1 | NIL | NIL | NIL | Did not pass | Did not pass | 20 | 4 | 8000 | 121 mg |
| | | | | | | | through | through | | | | |
| Comp B | 10 | 10 | 8 | NIL | NIL | 8 | 18 s | 70 s | 13 | 3 | 2580 | 65 mg |

Table 2. In the table, grip is indicated by a number from 1 to 10. The higher the number, the better the grip. The permeability tests involved placing a drop of liquid on the glove and measuring the time for ingression. The wearer trials relate to durability as assessed by a wearer in use. The higher the number, the better the perceived durability. Abrasion tests were according to EN388: 2003.
Comparative Example A is solid (i.e. non foam) nitrile (Nitrilon) glove.
Comparative Example B is a conventional air-foamed nitrile glove.

TABLE 3

| Dipping Process | |
|---|---|
| Pre-Coagulant | 2.5% Calcium Nitrate in Methanol |
| Drying Time | 90 Seconds Up, 90 Seconds Down |
| Compound Viscosity | 280 cps |
| Air % Volume | 15% |
| Dip Time | Slow Dipping |
| Post-Coag | 6% Acitic Acid in Methanol |
| Gelling | 10 Minutes |
| Leaching | 15 Minutes |
| Draining | 10 Minutes |
| Curing | 80 Minutes at 80° C. |

As indicated by the results in Table 2, gloves having foam polymer layers produced according to the invention have very much slower water and oil ingress than conventional foam polymer coated gloves. Both Example 1 and (especially) 2 also have excellent grip properties.

1. A method for manufacturing an foamed polymer, the method comprising,
providing a precursor dispersion comprising a precursor of a gellable polymer, particles of a water-swellable polymer and water, and gelling the gellable polymer to form a gelled polymer.

2. A method as claimed in claim 1, wherein the precursor of a gellable polymer is a plastisol or a latex.

3. A method as claimed in claim 2, wherein the latex is a latex of natural rubber, homopolymers or copolymers, for example, isoprene, chloroprene, acrylic ester acrylonitrile-butadiene copolymers, nitrile rubber, polychloroprene, styrene butadiene copolymers, butyl rubber, polybutadiene rubber, polyurethane or silicone.

4. A method as claimed in claim 1, wherein the water swellable polymer is a natural polymer, a modified natural polymer, a polyacrylate or a polyamide.

5. A method as claimed in claim 1, wherein the water swellable polymer is selected from gelatine, modified starch, modified cellulose, sodium polyacrylate, polyacrylamide copolymer, ethylene maleic anhydride copolymer, cross-linked carboxy methyl cellulose, polyvinyl alcohol copolymer, cross-linked polyethylene oxide, or a starch grafted copolymer of polyacrylonitrile.

6. A method as claimed in claim 1, further comprising introducing gas into the precursor dispersion to form a foam.

7. A method as claimed in claim 6, wherein less than 30% by volume gas is introduced into the precursor dispersion.

8. A method as claimed in claim 1, further comprising contacting the precursor dispersion with a coagulating agent to gel the gellable polymer.

9. A method as claimed in claim 8, wherein the coagulating agent comprises a water soluble nitrate or chloride, acetic acid, alcohol, ascorbic acid or citric acid.

10. A method as claimed in claim 9, wherein the coagulating agent comprises a calcium salt, preferably calcium nitrate.

11. A method as claimed in claim 1, further comprising dipping a former into the precursor dispersion and gelling the gellable polymer.

12. A method as claimed in claim 11, wherein the former is at least partially covered by a liner, preferably a textile liner.

13. A method as claimed in claim 11, wherein the former is at least partially coated with the coagulating agent before dipping.

14. A method as claimed in claim 11, wherein the former is coated with one or more layers of polymer before or after dipping the former in the precursor dispersion.

15. A method for manufacturing a garment, the method comprising,
a) providing a former,
b) optionally covering the former with a liner,
c) providing a precursor dispersion comprising a precursor of a gellable polymer, particles of a water swellable polymer and water,
d) dipping the former in the precursor dispersion to form a layer of the precursor of a gellable polymer on the former,
e) removing the former from the precursor dispersion, and
f) gelling the gellable polymer.

16. A method as claimed in claim 15, wherein the garment is a glove.

17. A method as claimed in claim 15, wherein the liner is a textile liner.

18. A method as claimed in claim 17, wherein the textile liner comprises one of or a blend of two or more of nylon, cotton, spandex, lycra, polyester, aramid, dyneema, acrylic, carbon conductive fibre, copper conductive fibre, thunderon conductive fibre, multifilament yarn spun from liquid crystal polymer (available under the brand name Vectran™), tacte1, CoolMax™, ThermaStat™, Thermax™ and Viafil®.

19. A method as claimed in claim 15, wherein the liner is a non-woven, a woven or knitted textile liner, preferably weft knitted.

20. A glove comprising a liner and at least one foamed polymer layer coated on the liner the foamed polymer layer comprising micropores formed by water swelling and contraction of particles of a water swellable polymer and mesopores formed by gas incorporated in the foamed polymer.
